(19) United States
(12) Patent Application Publication
(10) Pub. No.: US 2026/0030059 A1
(43) Pub. Date: Jan. 29, 2026

(54) METHOD AND DEVICE FOR TASK SCHEDULING, BOARD, AND COMPUTER-READABLE STORAGE MEDIUM

(71) Applicant: Shanghai Cambricon Information Technology Co., Ltd., Shanghai (CN)

(72) Inventors: Xinyu ZHANG, Shanghai (CN); Yanqiang GAO, Shanghai (CN)

(73) Assignee: Shanghai Cambricon Information Technology Co., Ltd., Shanghai (CN)

(21) Appl. No.: 18/880,158

(22) PCT Filed: Jun. 30, 2023
(86) PCT No.: PCT/CN2023/105069

§ 371 Date: Oct. 3, 2025

(30) Foreign Application Priority Data
Jul. 11, 2022 (CN) 202210817880.6

(51) Int. Cl. G06F 9/48

(52) U.S. Cl. CPC G06F 9/4887

(57) ABSTRACT

The present disclosure relates to a method for task scheduling and related products, where the related products include a device and a computer-readable storage medium. The device may be included in a computing processing apparatus of a combined processing apparatus, which may include one or more data processing apparatuses. The aforementioned combined processing apparatus may also include an interface apparatus and other processing apparatus. The computing processing apparatus interacts with other processing apparatus to jointly complete user specified computing operations. The combined processing apparatus may also include a storage apparatus, which is connected to the device and other processing apparatuses, respectively, to store data from the device and other processing apparatuses. The solution of the present disclosure may optimize scheduling operations and effectively overcome the shortcomings of existing scheduling strategies.

### CROSS REFERENCE TO RELATED APPLICATION

The present application claims priority to Chinese patent application No. 202210817880.6 with the title of “Method, device, board card and computer readable storage medium for task scheduling” filed on Jul. 11, 2022.

### TECHNICAL FIELD

The present disclosure relates generally to the field of computers. More specifically, the present disclosure relates to a method for task scheduling, a device, a board card, and a computer readable storage medium for executing the aforementioned method.

### BACKGROUND

In the field of heterogeneous computing, distributing and scheduling tasks based on streams is a current mainstream policy. Different users distribute tasks to a device through different streams, thereby fulfilling different computing requirements. In the scenario of multi-stream task distribution, the device is required to schedule tasks in all streams, and device resources are planned according to a fairness or a policy of a certain priority, so that appropriate resources are allocated to different streams for use. In some scenarios, the foregoing scheduling policy is based on a WF2Q-like algorithm. By using this algorithm, a scheduler that executes task scheduling may average IO (Input/Output) bandwidths allocated to a plurality of task channels, and serve all task channels within a certain delay.

However, using the prior art such as the WF2Q algorithm to allocate bandwidth to tasks in different task channels requires determining the execution time consumption of the tasks. In addition, every scheduling using the WF2Q algorithm needs to traverse and search all task channels, so as to search all task channels for task channels with submission time less than the global time and further select a task with the shortest time consumption for the IO from the searched task channels. Because of the limitation of the programming model and the requirements for performance of the heterogeneous computing platform, and especially the computing task and the IO task in the heterogeneous computing platform are not the same, the execution time consumption of the current task is usually not known before the task is executed. In addition, due to traversing and searching all task channels, the time complexity of scheduling a task using the WF2Q algorithm is O (2*log (N)+N), where N is the number of streams scheduled. As may be seen, as the number of streams increases, the delay it introduces will be unacceptable. In view of this, there is a need for an improved solution to meet the programming model constraints and performance requirements.

### SUMMARY

In view of the technical problems mentioned in the above background section, the present disclosure proposes a solution for efficiently performing task scheduling. By means of the solution of the present disclosure, a plurality of tasks distributed based on streams may be scheduled, thereby realizing effective task distribution and improving the efficient allocation of computing resources. To this end, the present disclosure provides solutions for task scheduling in various aspects as follows.

In a first aspect, the present disclosure provides a method for task scheduling, including: receiving one or more task streams to be scheduled, where each task stream includes one or more tasks to be distributed for execution: determining global time and submission time of each current initial task of the one or more task streams respectively: comparing the global time with the submission time of each current initial task to obtain a comparison result; and scheduling a current initial task, of which the comparison result satisfies a predetermined condition for distribution and execution.

In a second aspect, the present disclosure provides a device for task scheduling, including: a processor; and a memory, where the memory stores program instructions for task scheduling, and when the program instruction is run by the processor, the various embodiments described above and to be discussed below are implemented.

In a third aspect, the present disclosure provides a board card, including: one or more processing chips, each of which includes one or more processing cores: a control device and a driver program, which runs in the control device and includes a software scheduler, where when the driver program is executed under the control of the control device, the software scheduler is enabled to execute the various embodiments described above and to be discussed below so as to distribute tasks in each task stream to the processing chips.

In a fourth aspect, the present disclosure provides a computer-readable storage medium storing computer program instructions for task scheduling, which, when executed by a processor, implements the above method and various embodiments thereof to be discussed below.

By means of the scheduling solution provided in the foregoing aspects of the present disclosure, effective scheduling of stream tasks may be implemented, thereby overcoming defect of a WF2Q-like scheduling policy. Specifically, by directly determining the global time of the task stream and the submission time of the current initial task in each task stream, and by comparing the two to determine whether to distribute the current initial task, the solution of the present disclosure may avoid traversing and searching all task channels as in the prior art of WF2Q-like algorithms, thereby simplifying scheduling and reducing the performance overheads of the execution of the algorithm. Furthermore, since only the global time and the submission time are compared, the solution disclosed in the present invention also avoids the need to determine the IO time consumption of the tasks in the task stream, thereby further simplifying the scheduling operation.

### DRAWINGS

By reading the following detailed description with reference to the accompanying drawings, the above-mentioned and other objects, features and technical effects of the exemplary embodiments of the present disclosure will become easier to understand. In the accompanying drawings, several embodiments of the present disclosure are shown in an exemplary but not restrictive manner, and the same or corresponding reference numerals indicate the same or corresponding parts, where:

FIG. 1 is a simplified flowchart schematically illustrating a method for task scheduling in accordance with the present disclosure;

FIG. 2 is a flowchart schematically illustrating details of a method for task scheduling according to an embodiment of the present disclosure:

FIG. 3 is a detailed flowchart schematically illustrating a method for task scheduling according to an embodiment of the present disclosure:

FIG. 4 is a flowchart schematically illustrating two embodiments of a method for task scheduling according to an embodiment of the present disclosure:

FIG. 5 is a detailed flowchart schematically illustrating one embodiment shown in FIG. 4:

FIG. 6 is a schematic diagram illustrating a structure of a software and hardware architecture of data stream programming according to an embodiment of the present disclosure:

FIG. 7 is a block diagram illustrating a structure of a board card according to an embodiment of the present disclosure:

FIG. 8 is a block diagram illustrating a structure of a combined processing device according to an embodiment of the present disclosure:

FIG. 9 is a schematic diagram illustrating an internal structure of a computing device according to an embodiment of the present disclosure:

FIG. 10 is a schematic diagram illustrating an internal structure of a processor core according to an embodiment of the present disclosure; and

FIG. 11 is a schematic diagram illustrating data writing process between processor cores of different clusters in accordance with an embodiment of the present disclosure.

### DETAILED DESCRIPTION

Technical solutions in embodiments of the present disclosure will be described clearly and completely hereinafter with reference to the drawings in the embodiments of the present disclosure. Obviously, the embodiments to be described are merely some of, but not all of embodiments of the present disclosure. All other embodiments obtained by those skilled in the art based on the embodiments of the present disclosure without creative efforts shall fall within the protection scope of the present disclosure.

It should be understood that terms such as “first”, “second”, “third”, and “fourth” in the claims, the specification, and drawings are used for distinguishing different objects rather than describing a specific order. The terms “including” and “comprising” used in the specification and the claims of the present disclosure indicate the presence of described features, integers, steps, operations, elements and/or components, but do not exclude the presence or addition of one or more other features, integers, steps, operations, elements, components and/or collections thereof.

It should also be understood that the terms used in the specification of the present disclosure are merely for the purpose of describing particular embodiments rather than limiting the present disclosure. As being used in the specification and the claims of the present disclosure, unless the context clearly indicates otherwise, the singular forms “a”, “an” and “the” are intended to include the plural forms. It should also be understood that the term “and/or” used in the specification and the claims of the present disclosure refers to any and all possible combinations of one or more of relevant listed items and includes these combinations.

As being used in this specification and the claims, the term “if” can be interpreted as “when”, or “once” or “in response to a determination” or “in response to a detection” depending on the context. Similarly, the phrases “if it is determined” or “if | described condition or event| is detected” may be interpreted to mean “upon determination” or “in response to determination” or “upon detection of [described condition or event]” or “in response to detection of [described condition or event],” depending on the context.

+

As mentioned above, the solution of the present disclosure may be applied in the field of heterogeneous computing, for example, a heterogeneous computing platform formed by a host side and a device side. The host side herein may refer to a general-purpose processor, and the device side herein may be a special-purpose processor (such as an artificial intelligence chip) or a board card. In an embodiment, the host side and the device side may be integrated together, for example, the host side may be a general-purpose processor on a board card, and the device side may be a special-purpose processor on the same board card. In another embodiment, the host side and the device side may be separately provided.

In terms of application scenario of the present disclosure, the host side may have a task stream, the task stream may be a first in first out (FIFO) structure, the host side may schedule tasks therein based on the task stream, and distribute the tasks in the task stream to the device side, so that the device side may run the foregoing tasks, where the foregoing tasks include but are not limited to a computation task (for example, a convolution operation task) and a memory access task. For example, different users may distribute tasks from the host side to the device side through different task streams for execution, where each task stream may have one or more tasks. In order to achieve the expected execution of tasks on the device side, especially in scenarios where tasks are distributed in multi-task streams, the device side needs to reasonably schedule the tasks in all task streams. In order to overcome the deficiencies of the prior art as discussed in the background section, the solutions of the present disclosure propose utilizing a comparison of the submission time and the global time of the initial task of various task streams to determine whether to distribute the current initial task of that task stream for execution by the device side, thereby improving the efficiency of task scheduling execution and adapting to the programming model and performance requirements in a heterogeneous computing platform.

Detailed embodiments of the present disclosure are described below in detail with reference to the accompanying drawings.

FIG. 1 is a simplified flowchart schematically illustrating a method 100 for task scheduling in accordance with the present disclosure: It should be understood that the method 100 herein may be executed on a device side of a heterogeneous architecture system (including a host and a device).

As shown in the figure, in step S102, one or more task streams to be scheduled are received, where each task stream includes one or more tasks to be distributed for execution: each task stream may be in the form of a first in first out (FIFO) task channel; and a plurality of tasks in each task stream are sequentially scheduled according to the order in which the tasks enter the task stream.

In the context of this disclosure, the first task in each of the aforementioned task streams is referred to as the initial task for ease of description of the solution. As the task is scheduled and distributed, the initial task in each task stream is continuously changed until all the tasks in the task stream are scheduled and distributed. For example, assuming that task stream 1 has tasks 1 to 10, and the tasks 1 to 10 enter the task stream 1 in sequence, a task 1 at this time is the current initial task of the task stream 1. After the task 1 is distributed based on the solution of the present disclosure, a task 2 in the task stream 1 becomes the new current initial task, and the task 1 which has been distributed at this time becomes the previous initial task.

Next, in step S104, global time (“V_Time”) and submission time (“Start_Time”) of each current initial task (or “head task”) of one or more task streams are determined.

Regarding the global time of the present disclosure, it is dynamically changing and constantly cumulatively increasing with the number of tasks successfully scheduled to distribute. Specifically, the global time may be the sum of the submission time (described below) of all distributed tasks and the respective estimated execution time. Taking the task stream 1 including the tasks 1 to 10 as an example for illustration, when waiting to be distributed, the task 1 at this time is the current initial task and has corresponding global time 1, where the global time 1 is the sum of the submission time of all the distributed tasks (including a plurality of distributed tasks of other task streams) and the respective estimated execution time before the task 1 is distributed. After the task 1 is determined to be able to be distributed, the task 2 will become the current initial task, and its corresponding global time 2 will be the global time 1 plus the submission time of the task 1 and the estimated execution time of the task 1 (the estimated execution time will be described in detail later). Thus, it may be seen that the global time of the present disclosure is a dynamically changing, ever-cumulatively increasing value.

According to the context of the present disclosure, the submission time of the task may be the time at which the task is submitted into the task stream, which also equals to the global time at this time. Next, at step S106, the global time and the submission time of each current initial task are compared to obtain a comparison result. Finally, at step S108, the current initial task, of which the comparison result satisfies a predetermined condition, is scheduled for distribution and execution.

As an implementation scenario, when the foregoing submission time is less than the global time, the current initial task may be scheduled for distribution, so that it may be executed by a processing unit or processing core on the device side with a certain amount of computing resources. As described above, after the aforementioned current initial task is scheduled to be distributed, the next task in the task stream to which the current initial task belongs will become the current initial task in the task stream and wait to be scheduled and distributed.

Through the execution of the above method 100, the solution of the present disclosure may effectively schedule the current initial task in the task stream. In one scenario, this solution cyclically executes the plurality of rounds of determining the global time, determining the submission time, comparing, and scheduling the current initial task, of which the comparison result satisfies the predetermined condition to perform distribution until one or more tasks in each of the task streams are all distributed. It may be seen that the solution of the present disclosure may relatively easily determine the next task to be scheduled and distributed by simply comparing the global time and the submission time, thereby simplifying the scheduling operation with respect to the prior art, especially the existing algorithm which needs to consider the time consumption of the IO. In addition, since only the current initial task in various task streams needs to be processed, the solution of the present disclosure does not need to traverse or search all the tasks of all the streams, so as to determine the tasks that need to be scheduled and distributed. Thus, the solution of the present disclosure improves the performance and efficiency of the scheduling algorithm, thereby being more suitable for distributing and executing the multi-task streams in a heterogeneous computing platform.

It should be noted that the description of the disclosed solution in combination with the method steps shown in FIG. 1 is only exemplary and not restrictive. Those skilled in the art may adjust or change the execution order of the method 100 according to actual application scenarios. For example, although FIG. 1 determines the global time first and then the submission time in step S104, the order of determining the two is not limited thereto, and those skilled in the art may also determine the submission time first and then the global time, or determine both at the same time, according to actual scenarios.

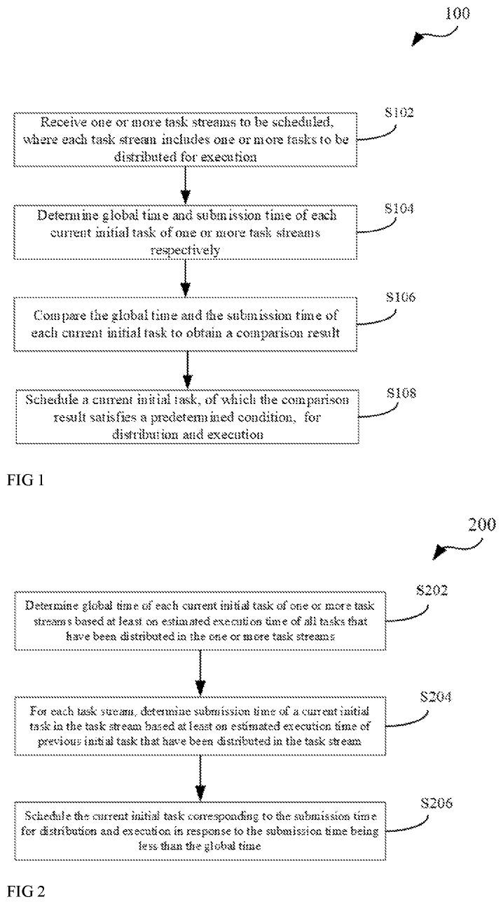

FIG. 2 is a schematic diagram schematically illustrating a method 200 for task scheduling according to an embodiment of the present disclosure: Based on the description in combination with FIG. 1, those skilled in the art may understand that method 200 further illustrates how to effectively and cyclically perform the plurality of rounds of operations (i.e., the four steps shown in FIG. 1) for the plurality of tasks in the plurality of task streams until the processing details of one or more tasks in each of the aforementioned task streams are distributed. Further, after each round of operation is completed, the embodiments of the present disclosure may dynamically update parameters such as the global time and the submission time, and for details, reference may be made to the following description. Therefore, the embodiment of the present disclosure may execute the above four steps according to the updated parameters, thereby completing the distribution of each task in the task stream.

As shown in FIG. 2, at step S202, the global time is determined based at least on the estimated execution time of all tasks that have been distributed in the one or more task streams.

According to the characteristics of heterogeneous computing and application scenarios, in order to achieve better performance, a task mode of a task in a task stream within a relatively long time range tends to be fixed, in other words, a user usually distributes a task of the same mode to a task stream repeatedly to complete a certain specific task. In view of this, the solution of the present disclosure proposes to estimate the time required to execute the current task based on the predicted time of historical execution tasks in the task stream, which is the foregoing estimated execution time (also referred to as “IO time-consuming time”), which may be expressed by the following formula (1):

$$ExecutionTime ( Future ) \approx \frac{{\sum }_{n} ExecutionTime ( Past )}{n} \qquad ( 1 )$$

where ExecutionTime (Future) represents the estimated execution time of future tasks, ExecutionTime (Past) represents the execution time of the past tasks, and n represents the number of tasks. Therefore, the present disclosure may well estimate the execution time of a future task using the execution time of completed tasks. Among them, this task may be the task currently being scheduled and distributed, and the corresponding global time after the task is distributed may be used as the global time corresponding to the current initial task to be scheduled. Fo example, this task may be a previous initial task of the current initial task to be distributed, and in the embodiment of the present disclosure, the estimated execution time of the previous initial task may be determined firstly based on all the tasks which are scheduled and distributed before the previous initial task. Thereafter, as described above, by comprehensively considering (for example, by summing) the global time corresponding to the previous initial task and the estimated execution time calculated using the above formula (1), the global time after the previous initial task is distributed may be determined. For example, the global time after the previous initial task is distributed may be equal to the sum of the global time before the previous task is distributed and the estimated execution time of the previous initial task.

In some scenarios, the update of the global time and/or completion time of the present disclosure may be related to the priority of various task streams, thereby taking priority into account in the determination of the completion time and the global time. The priority of various task stream will be described in detail later.

Next, at step S204, the submission time of the current initial task to be distributed in the task stream is determined based at least on the estimated execution time of the previous initial task distributed in the task stream. Here, the submission time of the current initial task may be equal to the submission time of the previous initial task plus its estimated execution time. As an example, the estimated execution time of the previous initial task may also be obtained in the manner shown in the foregoing formula (1), and the present disclosure does not impose any limitation in this aspect. Finally, at step S206, in response to the submission time of the current initial task being less than the global time, the current initial task corresponding to the submission time is scheduled for distribution and execution.

It may be understood that, for ease of description. FIG. 2 only shows a round of operation of the present disclosure. On the basis of the foregoing description, those skilled in the art may understand that after step S206, the solution of the present disclosure performs a next round of operation for a plurality of subsequent current initial tasks (which are transformed from tasks following a previous initial task), and repeats this cycle until all tasks in the plurality of streams are distributed.

From the foregoing description combined with FIG. 2, those skilled in the art may understand that when tasks are continuously distributed in a task stream according to the present disclosure, the completion time of the task will be updated to the submission time of the task in the task stream each time it is completed. Thus, the submission time of the present disclosure contains the completion time of the task which has been distributed. Based on this, determining whether the task may be distributed by comparing the submission time with the global time is equivalent to determining whether the task may be distributed by comparing the completion time with the global time.

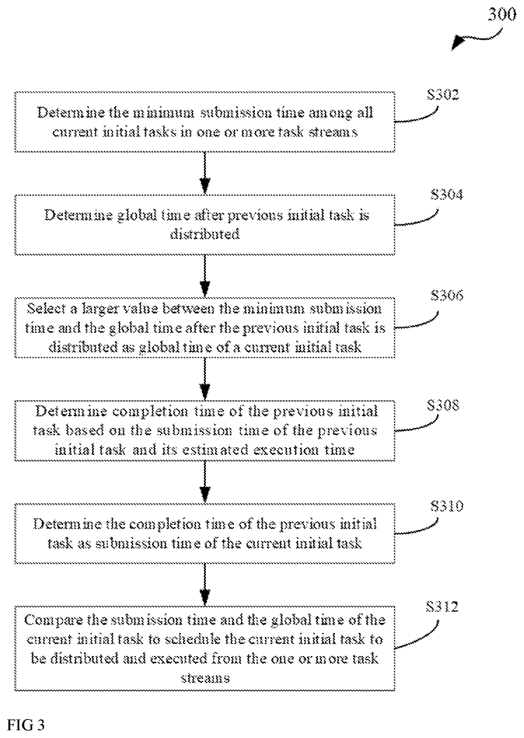

FIG. 3 is a detailed flowchart schematically illustrating a method 300 for task scheduling according to an embodiment of the present disclosure: It will be appreciated that the method 300 further shows further details regarding the foregoing method 100 and method 200. Thus, the previous description of the method 100 and method 200 is equally applicable to the method 300 and the same will not be repeated hereinafter.

As shown in FIG. 3, at step S302, the minimum submission time (“Min_Start”) among all current initial tasks in the one or more task streams is determined. According to the context of the present disclosure, the minimum submission time may be the earliest submission time selected from all current initial tasks as the minimum submission time. For example, it is assumed that there are currently three task streams from the first task stream to the third task stream, where the submission time of the current initial task in the first task stream is 5 minutes and 20 seconds, the submission time of the current initial task in the second task stream is 5 minutes and 21 seconds, and the submission time of the current initial task in the third task stream is 5 minutes and 22 seconds. According to the solution of the present disclosure, in this example, the submission time of the current initial task in the first task stream is the earliest submission time, and thus 5 minutes and 20 seconds may be determined as the minimum submission time among all the current initial tasks in the three task streams.

Next, at step S304, the global time after the previous initial task is distributed is determined. The method for determining the global time after the previous task is distributed may refer to the embodiment shown in FIG. 2.

At step S306, a larger value between the minimum submission time (“Min_Start”) and the global time (V_Time) after the previous initial task is distributed is selected as the global time of the current initial task, which is. V_Time (Current)=Max (Min_Start. V_Time).

At step S308, the completion time of the previous initial task is determined based on the submission time of the previous initial task and its estimated execution time, in other words. Finish_Time=Start_Time+Average_Time/Weight, where Start_Time represents the submission time of the previous initial task, and Average_Time/Weight represents the estimated execution time of the previous initial task, where the Average_Time is an estimated execution time without considering the priority of the task stream to which the task belongs, and the Average_Time may be calculated with reference to the above formula (1), while Weight represents a priority value of the task stream, for example, the priority value may be 1-8, which is not specifically limited herein.

In an application scenario, one or more task streams of the present disclosure may be from different users and different task streams may have different priorities as mentioned above. This priority may be used as a basis for prioritizing scheduling of tasks, whereby a task with a higher priority means that the device will schedule it first, thereby facilitating the fast and efficient execution of the task. Conversely, a task with a lower priority means that the device will not schedule this task as early as possible. As an example, assuming that there are three task streams, the task stream 1, the task stream 2, and the task stream 3, the user may set the priority from high to low as the task stream 1>the task stream 2>the task stream 3, or as the task stream 2>the task stream 1>the task stream 3, according to the intended scheduling priority order. It will be appreciated that the higher the priority, the faster the task will be scheduled for execution on a heterogeneous computing platform or system.

At step S310, the completion time of the previous initial task is determined as the submission time of the current initial task. Finally, at step S312, the submission time and the global time of the current initial task are compared to schedule the current initial task to be distributed and executed from the one or more task streams. In one embodiment, when the submission time of the current initial task in the task stream is less than the global time, in other words, Start Time<V_Time (Current), it is determined that the current initial task satisfies the task distribution condition, and the current initial task may be scheduled for distribution. This is looped until all of the tasks in the task stream are distributed.

As described above, for the sequential scheduling of a plurality of tasks of a plurality of task streams, after the current initial task is distributed completely, the solution of the present disclosure updates the task submission time in the current task stream, the completion time and the global time of the task in the current task stream, so as to be used for the scheduling of the current initial task in the next round or subsequent task streams.

Specifically, it may be first determined that the submission time of the initial task of the next round (i, e., the current initial task) is equal to the completion time of the previous initial task distributed, which may be exemplarily expressed as the following formula (2):

$$Start\_Time = Finish\_Time \qquad ( 2 )$$

As an example, it may be determined that the completion time of the previous initial task distributed is equal to the sum of the submission time of the previous initial task and the estimated execution time of the previous initial task, which may be exemplarily expressed as the following formula (3):

$$Finish\_Time = Start\_Time + Average\_Time / Weight , \qquad ( 3 )$$

where

the Average_Time is used to indicate the estimated execution time without considering the task stream to which the task belongs, while the weight is used to indicate the priority value of the task stream.

Further, it may be determined that the global time corresponding to the next round of task scheduling (i, e, the global time corresponding to the current initial task) is equal to the maximum value between the minimum task submission time in all task streams and the global time of the previous initial task distributed, which may be exemplarily expressed as the following formula (4):

$$V\_Time = Max ( Min\_Start , V\_Time + Average\_Time / Total\_Weight ) , \qquad ( 4 )$$

where “Total_Weight” represents an accumulated priority value of all task streams, and the accumulated priority is a priority obtained by weighting the priorities of all the task streams. For example, for the task stream 1, the task stream 2, and the task stream 3, the priority 3, the priority 2, and the priority 1 may be assigned respectively and the weight 0.7, the weight 0.2, and the weight 0.1 may be set respectively, so as to obtain an accumulated priority value 3×0.7+2×0.2+1×0.1=2.6.

Specifically, the present disclosure further includes a task initialization stage for pushing a task to a corresponding task stream, in other words, when the task in the task stream is scheduled and distributed for the first time, the submission time of the current initial task and the corresponding global time thereof are determined as follows:

First, the completion time of the current initial task is determined based on the submission time of the current initial task and its estimated execution time, in other words. Finish_Time=Start_Time+Average_Time/Weight, where Start_Time represents the submission time of the current initial task, and Average_Time/Weight represents the estimated execution time of the current initial task, where the Average Time is an estimated execution time without considering the priority of the task stream to which the task belongs, while Weight represents the priority value of the task stream.

Secondly, a larger value between the completion time of the current initial task and the global time (V_time) corresponding to the current initial task is selected as the submission time of the current initial task, in other words. Start_Time=Max (V_Time. Finish_Time), and the current initial task herein is also a candidate first task among a plurality of streams waiting to be determined whether it will be distributed for execution in this round.

Finally, the submission time and the global time of the current initial task are compared to schedule the current initial task to be distributed and executed from the one or more task steams. In one embodiment, when the submission time of the current initial task in the task stream is less than the global time, in other words. Start_Time<V_Time (Current), it is determined that the current initial task satisfies the task distribution condition, and the current initial task may be scheduled for distribution. Then, the global time and the submission time of the current initial task may be updated according to the manner shown in FIG. 3, so as to complete the scheduling and distribution of all the tasks in the task stream.

Compared to the prior art, the solution of the present disclosure discard operation that seeks the minimum completion time. Instead, the present disclosure uses the submission time as a basis for determining whether a task may be distributed. Since the solution of the present disclosure only searches for the minimum submission time during execution, the time complexity of scheduling a task at this time is reduced to 0) (2*log (N)). From the foregoing description, those skilled in the art may understand that the reason why the solution of the present disclosure may perform the aforementioned optimization is due to the following technical improvement: when tasks in the task stream are continuously distributed, the completion time of the task will be updated to the submission time of tasks in the task stream after each successful scheduling. Thus, the submission time of the present disclosure contains the completion time of the task which has been distributed. Based on this, determining whether the task may be distributed by comparing the submission time with the global time is equivalent to determining whether the task may be distributed by comparing the completion time with the global time.

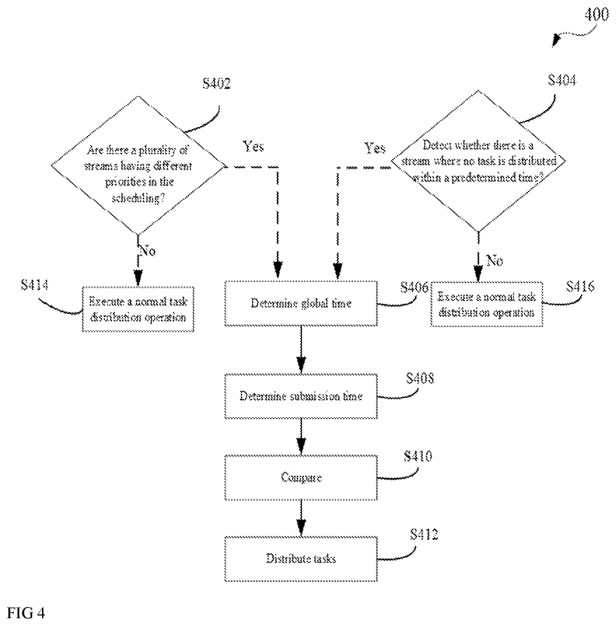

In order to achieve flexibility in task scheduling, the solution of the present disclosure further proposes dynamic switching based on the task mode distributed by a user to determine whether to trigger the use of the scheduling method above. In view of this, in order to ensure the calculation performance in a normal condition, the present disclosure proposes that the described scheduling policy is started only when the following two conditions are satisfied: condition 1): when task streams with different priorities are detected (in other words, when a user has a clear priority configuration on computing resources of different task streams), the scheduling policy of the present disclosure is started; and/or condition 2) when the task in a certain task stream has not been distributed for a long time (in other words, the task in some task streams has not been scheduled for a long time, thereby destroying the fairness principle), the scheduling policy of the present disclosure is started. To better understand the triggering process, the following describes the triggering process with reference to FIG. 4.

FIG. 4 is a flowchart schematically illustrating two embodiments of a method 400 for task scheduling according to the present disclosure: As mentioned above, the method 400 shows two conditions for triggering the scheduling policy of the foregoing disclosure, in other words, those shown at steps S402 and S404.

As shown in FIG. 4, in one embodiment, at step S402, it is detected whether there are a plurality of task streams having different priorities in the task scheduling. In response to detecting a plurality of task streams having different priorities, the process proceeds to step S406, in other words, the scheduling task described in the foregoing with reference to the accompanying drawings is started to be executed: otherwise, the process advances to step S414. At step S414, a normal task distribution operation starts to be executed. In the embodiment of the present disclosure, at step S414, the task distribution operation may be executed according to, for example, a Round-Robin mechanism until the tasks in all task streams are distributed to the device side for execution.

In another embodiment, at step S404, it is detected whether there is a task stream where no task is distributed within a predetermined time. In response to detecting that there is a task stream where no task is distributed within a predetermined time, the process proceeds to step S406, in other words, the scheduling task described in the foregoing with reference to the accompanying drawings is started to be executed: otherwise, the process proceeds to step S416. At step S416, a normal task distribution operation starts to be executed. In the embodiment of the present disclosure, at step S416, the task distribution operation may be executed according to, for example, a Round-Robin mechanism until the tasks in all task streams are distributed to the device side for execution.

At steps S406. S408. S410, and S412, the process respectively performs operations of determining the global time, determining the submission time, comparing, and distributing tasks based on the results of the comparison operation. Since the above-mentioned determining, comparing and distributing operations have been described in detail in conjunction with the accompanying drawings, they will not be repeated here.

In one embodiment of the present disclosure, at step S402, it is detected whether there are a plurality of task streams having different priorities in the task scheduling. Next, at step S404, it is detected whether there is a task stream where no task is distributed within a predetermined time. In response to a plurality of task streams having different priorities and there is at least one task stream where no task is distributed within a predetermined time, at this time, the task is distributed to the device side according to steps S406, S408, S410 and S412. At steps S406. S408. S410, and S412, the process may respectively perform operations of determining the global time, determining the submission time, comparing, and distributing tasks based on the result of the comparison operation. Since the above-mentioned determining, comparing and distributing operations have been described in detail in conjunction with the accompanying drawings, they will not be repeated here.

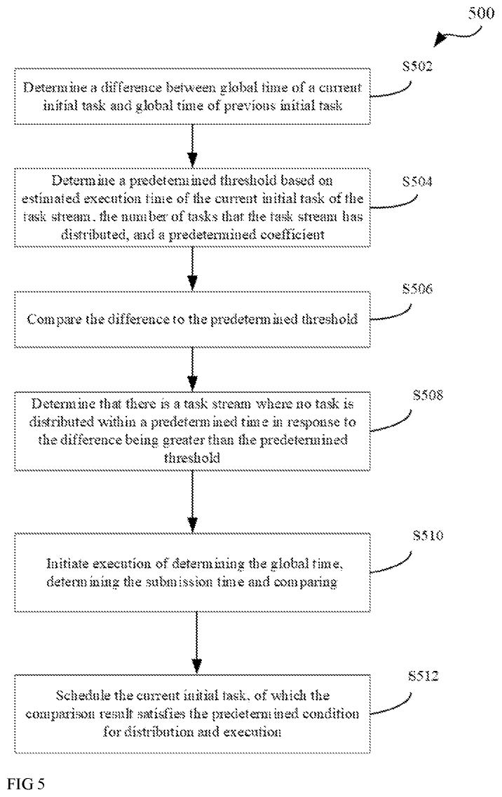

FIG. 5 is a detailed flowchart schematically illustrating detecting whether there is a task stream where no task is distributed within a predetermined time in FIG. 4. As shown in FIG. 5, at step S502, a difference between the current global time and the global time when the task stream submits the task last time is determined, in other words. Wait_Time=V_Time (Current)-V_Time (Last), where the waiting time Wait_Time represents a difference between these two global time. V_Time (Current) represents a current global time, and V_Time (Last) represents the global time when the task is last submitted in the current task stream. Next, at step S504, a predetermined threshold is determined based on the estimated execution time of the current initial task of the task stream, the number of tasks that the task stream has distributed, and a predetermined coefficient. As an example, the determination process herein may be represented by the following formula (5):

$$Threshold = Average\_Time \cdot Pushed\_Task \cdot Factor , \qquad ( 5 )$$

Threshold represents a predetermined threshold value. Average_Time represents an estimated execution time of a current initial task. Pushed_Task represents the number of tasks that have been distributed by a task stream, and Factor represents a predetermined coefficient, which may be used to characterize the number of other task streams and the overall impact of task execution time in other task streams.

At step S506, the difference is compared to the predetermined threshold. Next, at step S508, in response to the difference being greater than the predetermined threshold, it is determined that there is a task stream where no task is distributed within a predetermined time. Thereafter, at step S510, execution of the determining the global time, the determining the submission time and comparing is initiated. Finally, at step S512, the current initial task, of which the comparison result satisfies the predetermined condition (in other words, the submission time is less than the global time), is scheduled for distribution. Since the operations of steps S510 and S512 herein are the same as those described above, they will not be described again for the sake of brevity.

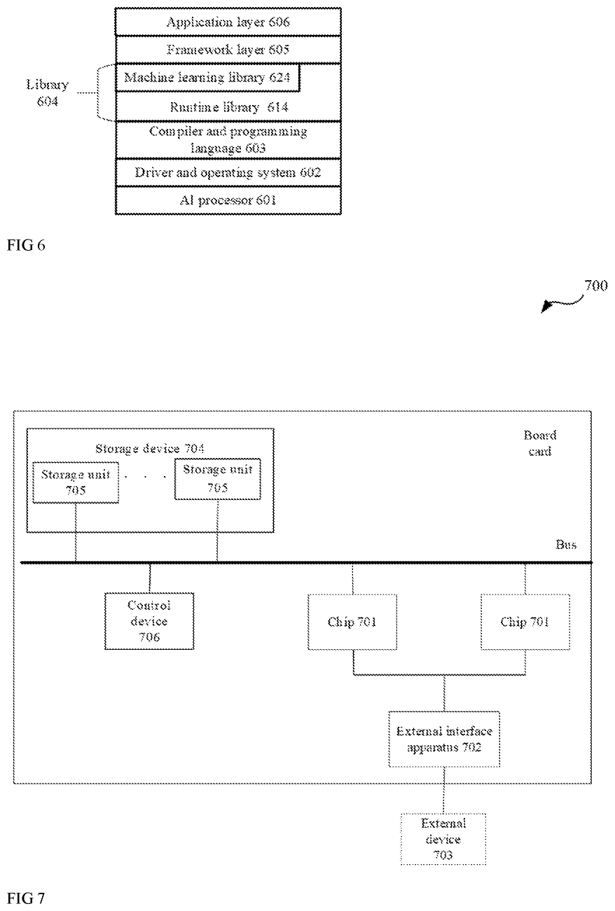

FIG. 6 shows a design diagram of a software and hardware architecture in an embodiment of the present disclosure. As shown in the figure, the software and hardware architecture in this embodiment may include an artificial intelligence (AI) processor 601, a driver and operating system 602, a compiler and programming language 603, a library 604, a framework layer 605, and an application layer 606. It should be understood that the software and hardware architecture herein may be applied to the artificial intelligence computing system or the heterogeneous computing platform of the present disclosure.

Specifically, the AI processor 601 (which may be included, for example, in a board card described below in connection with the figures) considers both computational optimization and data conveyance optimization in hardware design. To this end, it employs a customized operation unit to speed up arithmetic, and uses on-chip storage to speed up data conveyance, thereby obtaining extremely high performance and energy efficiency ratio. In addition, in order to support various algorithm optimizations, the AI processor 601 may have customized operation units and instruction sets, where the instruction sets may provide computation instructions (scalar, vector, and/or matrix) of different granularity. Further, when considering various factors such as algorithm access characteristics, hardware costs, verification difficulties, and so on, an on-chip storage manner may be adopted and data conveyance may be optimized. In actual operation, the speed of the AI processor of the present disclosure may be dozens of times faster than that of a mainstream graphics processing unit (GPU).

The driver and operating system 602 are primarily responsible for implementing scheduling of tasks on the AI processor 601. The scheduling operation may, for example, implement scheduling according to task priorities, communication and synchronization among a plurality of devices, and so on. For the compiled program, the scheduling and execution of tasks to be implemented on specific processors may be achieved through the operating system and drivers, including but not limited to the following operations: allocating and releasing device memory, realizing data transmission between devices, maintaining task queues, and scheduling tasks according to the priority to achieve synchronization and collaboration among a plurality of devices.

The compiler and programming language 603 may be an assembly language developed for the instruction set of the AI processor 601. In applications, it may translate deep learning operators developed for the AI processor 601 into processor instruction combinations to facilitate calling the AI processor 601 and thus efficiently use the AI processor 601. In some application scenarios, a compiler may be utilized to perform intermediate expression stages of compilation to optimize compilation.

The library 604 may include a runtime library 614 and a machine learning library 624. In an implementation scenario, the foregoing library 604 may use an instruction set of the AI processor 601 and perform partial optimization according to the instruction set of the A1 processor 601, so as to improve a running speed of an operator. The runtime library 614 may be a set of high-performance operator libraries specially developed for the AI processor 601, and it may be used to complete the interaction between the general-purpose processor and the artificial intelligence processor. Further, the runtime library 614 may also provide a set of artificial intelligence processor-oriented interfaces. For the machine learning library 624, it may be used to accelerate various machine learning or deep learning algorithms on the artificial intelligence processor. Specifically, the machine learning library 624 may provide an efficient, universal, flexible and extensible programming interface, and a machine learning application on an upper layer of the machine learning library 624 may directly use programming interfaces of various programming frameworks (for example. Pytorch. TensorFlow. Caffe. MxNet. and the like), and may also directly program by using the interface provided by the machine learning base 624. In addition, the machine learning library 624 of the present disclosure may facilitate calling of a hardware platform, and the runtime library 614 may implement some basic common operators, such as various operations like convolution and pooling.

The framework layer 605 may add encapsulation for operators developed for AI processors.

and mainly encapsulates operators of the runtime library 614. In addition, the framework layer 605 may also modify related task scheduling or memory management and other parts. In an application scenario, the framework layer 605 may adopt the architecture of a framework such as TensorFlow.

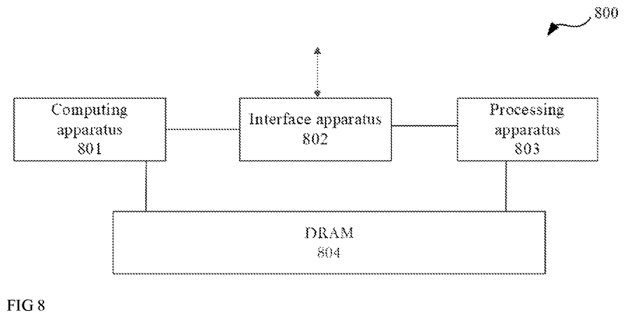

The device side in the embodiment of the present disclosure may be an artificial intelligence chip, a board card, or the like. FIG. 7 illustrates a schematic diagram of a structure of a board card 700 according to an embodiment of the present disclosure. As shown in FIG. 7, the board card 700 includes a chip (or also known as “processing chip”) 701, which is a system-level chip, or also known as system on chip (SoC), integrating one or more combined processing devices. The combined processing device is an artificial intelligence operation unit used to support various deep learning and machine learning algorithms to meet the intelligent processing needs in complex scenarios in the fields of computer vision, speech, natural language processing, data mining, and so on. Especially, deep learning technologies are widely applied in the field of cloud intelligence. A prominent feature of a cloud intelligence application is that the amount of input data is large, which has a high requirement on a storage capability and a computing capability of a platform. A board card 700 in this embodiment is applicable to a cloud intelligence application, and has a huge off-chip storage, an on-chip storage, and a powerful computing capability.

The chip 701 is connected to an external device 703 via an external interface apparatus 702. The external device 703 is, for example, a server, a computer, a camera, a display, a mouse, a keyboard, a network card, or a WIFI interface and so on. The data to be processed may be transmitted from the external device 703 to the chip 701 via the external interface apparatus 702. The computation results of the chip 701 may be transmitted back to the external device 703 via the external interface apparatus 702. According to different application scenarios, the external interface apparatus 702 may have different interface forms, for example, a Peripheral Component Interconnect Express (PCIe) interface and so on.

The board card 700 also includes a storage device 704 for storing data, which includes one or more storage units 705. The storage device 704 is connected to the control device 707 and the chip 701 through a bus for data transmission. The control device 706 in the board card 700 is configured to regulate and control the state of the chip 701. To this end, in an application scenario, the control device 706 may include a singlechip, also known as a micro controller unit (MCU). In an application scenario of a scheduling solution in the present disclosure, the control device may run a driver and includes a software scheduler. When the aforementioned driver is controlled and run by the control device, the software scheduler executes the foregoing method procedure described with reference to FIG. 1 to FIG. 5, so as to distribute tasks in each task stream to a processing chip for execution.

FIG. 8 is a diagram showing the structure of a combined processing apparatus 800 in the chip 701 of this embodiment. As shown in FIG. 8, the combined processing apparatus 800 includes a computing apparatus 801, an interface apparatus 802, a processing apparatus 803, and a dynamic random access memory (DRAM) 804.

The computing apparatus 801 is configured to execute an operation specified by a user, and is mainly implemented as a single-core intelligent processor or a multi-core intelligent processor, and is configured to execute depth learning or computation of machine learning. The computing apparatus 801 may interact with the processing apparatus 803 through the interface apparatus 802 to jointly complete the operation specified by the user.

The interface apparatus 802 is configured to transfer data and control instructions between the computing apparatus 801 and the processing apparatus 803. For example, the computing apparatus 801 may obtain input data from the processing apparatus 803 via the interface apparatus 802 and write the data into the storage device on the chip of computing apparatus 801. Further, the computing apparatus 801 may obtain control instructions from the processing apparatus 803 via the interface apparatus 802 and write to a control cache on the chip of computing apparatus 801. Alternatively or optionally, the interface apparatus 802 may also read data in a memory device of the computing apparatus 801 and transmit the data to the processing apparatus 803.

The processing apparatus 803 executes basic control including, but not limited to, data transfer, and turning on and/or stopping of the computing apparatus 801 as a general-purpose processing device. According to different implementations, the processing apparatus 803 may be a central processing unit (CPU) or a graphics processing unit (GPU) or one or more types of processors in other general-purpose and/or special-purpose processors. These processors include, but not limited to, a digital signal processor (DSP), an application specific integrated circuit (ASIC), a field-programmable gate array (FPGA) or another programmable logic device, a discrete gate or transistor logic device, a discrete hardware component, or the like. Furthermore, the number may be determined according to actual requirements. As mentioned above, only with respect to computing apparatus 801 of the present disclosure, it may be viewed as having a single-core structure or a homogeneous multi-core structure. However, when the computing apparatus 801 and the processing apparatus 803 are considered together, they are considered to form a heterogeneous multi-core structure.

The DRAM 804 is configured to store to-be-processed data, which may be a double data rate (DDR) memory, and generally has a size of 16G or larger, and is configured to store data of the computing apparatus 801 and/or the processing apparatus 803. In one or more implementation scenarios, the memory management solution of the present application may be applied to the management and maintenance of the DDR, thereby realizing the reuse or recycling operation of events. In this case, the board of the present application may be regarded as the device side in the artificial intelligence computing system.

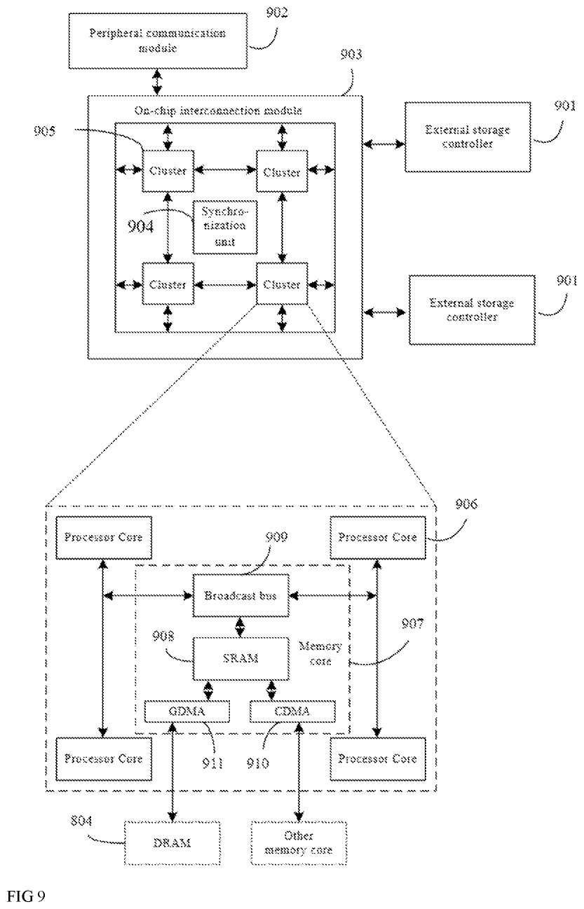

FIG. 9 illustrates a schematic diagram of the internal structure of the computing apparatus 801. The computing apparatus 801 is used to process input data such as computer vision, speech, natural language, and data mining. The computing apparatus 801 in the figure adopts a multi-core hierarchical structure design. As a system on chip, the computing apparatus 801 includes a plurality of clusters, each of which includes a plurality of processor cores that may be used to execute the tasks distributed in the present disclosure. In other words, the computing apparatus 801 is constructed in the hierarchy of system on chip-cluster-processor core.

From the perspective of a system-on-chip hierarchy, as shown in FIG. 9, the computing apparatus 801 includes an external storage controller 901, a peripheral communication module 902, an on-chip interconnection module 903, a synchronization module 904, and a plurality of clusters 905.

There may be a plurality of external storage controllers 901, two are exemplarily shown in the figure, and are configured to access an external storage device (for example, the DRAM 804 in FIG. 8) in response to an access request sent by a processor core, so as to read data from an off-chip or write data into the external storage device. The peripheral communication module 902 is configured to receive a control signal from the processing apparatus 803 via the interface apparatus 802, and start the computing apparatus 801 to execute a task. The on-chip interconnection module 903 connects the external memory controller 901, the peripheral communication module 902 and the plurality of computation clusters 905 to transmit data and control signals among the modules. The synchronization module 904 is a global barrier controller (GBC), and is configured to coordinate the work progress of each cluster to ensure information synchronization. The plurality of clusters 905 are the computational cores of computing apparatus 801. Four are exemplarily illustrated in the figure. With the development of hardware, the computing apparatus 801 of the present disclosure may also include eight, sixteen, sixty-four, or even more clusters 905.

From the cluster level, as shown in FIG. 9, each cluster 905 includes a plurality of processor cores (IPU Cores) 906 and a memory core (MEM Core) 907.

Processor core 906 is illustrated exemplarily in the figure as four, and the present disclosure does not limit the number of processor cores 906. Its internal architecture is shown in FIG. 9. Each processor core 906 includes three major modules: a control module 91, a computing module 92 and a storage module 93.

The control module 91 is configured to coordinate and control the work of the computing module 92 and the storage module 93 to complete a task of depth learning, and the control module 91 includes an instruction fetch unit (IFU) 1011 and an instruction decoding unit (IDU) 1012. The instruction fetch unit 1011 is used to fetch instructions from the processing apparatus 803, and the instruction decoding unit 1012 decodes the fetched instructions and sends the decoding results as control information to the computing module 92 and the storage module 93.

The computing module 92 includes a vector computing unit 1021 and a matrix computing unit 1022. The vector computing unit 1021 is used to perform vector computation and may support complex computations such as vector multiplication, addition, nonlinear transformation and so on: the matrix computing unit 1022 is responsible for the core computations of the deep learning algorithm, for example, matrix multiplication and convolution.

The storage module 93 is used to store or transport related data, including a Neuron RAM (NRAM) 1031, a Weight RAM (WRAM) 1032, an Input/Output Direct Memory Access (IODMA) 1033, and a Move Direct Memory Access (MVDMA) 1034. The NRAM 1031 is used to store input, output data and intermediate results for computation by the processor core 906; the WRAM 1032 is used to store the weights of the deep learning network: the IODMA 1033 controls memory access between the NRAM 1031/the WRAM 1032 and the DRAM 804 through the broadcast bus 909; the MVDMA 1034 is used to control memory access between the NRAM 1031/the WRAM 1032 and the SRAM 908.

Returning to FIG. 9, the memory core 907 serves primarily to store and communicate, in other words, to store shared data or intermediate results among the processor cores 906, as well as to perform communications between the cluster 905 and the DRAM 804, communications among the computing clusters 905 to each other, communications among the processor cores 906 to each other, and so forth. In other embodiments, the memory core 907 has the capability of scalar operations to perform scalar operations.

The memory core 907 includes a shared memory (SRAM) 908, a broadcast bus 909, a cluster direct memory access (CDMA) 910, and a global direct memory access (GDMA) 911. The Static Random Access Memory (SRAM) 908 plays the role of a high-performance data relay station. The data reused between different processor cores 906 within the same the cluster 905 does not need to be obtained from the DRAM 804 by each processor core 906, but is relayed between the processor cores 906 through the SRAM 908. The memory core 907 only needs to quickly distribute the reused data from the SRAM 908 to a plurality of processor cores 906 to improve inter core communication efficiency and greatly reduce on-chip and off chip input/output access.

The broadcast bus 909, the CDMA 910, and the GDMA 911 are respectively used to perform communication between the processor cores 906, communication between the clusters 905, and data transmission between the clusters 905 and the DRAM 804. The following will explain them separately.

The broadcast bus 909 is used to complete high-speed communication between the processor cores 906 in the cluster 905. The broadcast bus 909 of this embodiment supports inter-core communication modes including unicast, multicast and broadcast. Unicast refers to point-to-point (in other words, from a single processor core to a single processor core) data transmission, multicast is a communication mode of transmitting a piece of data from the SRAM 908 to specific several processor cores 906, and broadcast is a communication mode of transmitting a piece of data from the SRAM 908 to all processor cores 906, which is a special case of multicast.

The CDMA 910 is used to control the memory access of the SRAM 908 between different clusters 905 in the same computing apparatus 801. FIG. 11 shows a schematic diagram when a processor core intends to write data to a processor core of another cluster to illustrate the working principle of the CDMA 910. In this application scenario, the same computing device includes a plurality of clusters. For the convenience of explanation, only the cluster 0 and the cluster 1 are shown in the figure. The cluster 0 and cluster 1 each include a plurality of processor cores. For the convenience of explanation, the cluster 0 in the figure only shows the processor core 0 and the cluster 1 only shows the processor core 1. The processor core 0 intends to write data to the processor core 1.

First, the processor core 0 sends a unicast write request to write data to the local SRAM 0 The CDMA 0) acts as the master end and the CDMA 1 acts as the slave end. The master end pushes a write request to the slave end, in other words, the master end sends a write address AW and write data W to transfer the data to the SRAM 1 of the cluster 1. Then the slave end sends a write response B as a response. Finally, the processor core 1 of the cluster 1 sends a unicast read request to read the data from the SRAM 1.

Returning to FIG. 9, the GDMA 911 cooperates with the external memory controller 901 to control the memory access of the SRAM 908 of the cluster 905 to the DRAM 804, or reads data from the DRAM 804 to the SRAM 908. As mentioned above, the communication between the DRAM 804 and the NRAM 1031 or the WRAM 1032 may be realized through two channels. The first channel is to directly connect the DRAM 804 and the NRAM 1031 or the WRAM 1032 through the IODAM 1033; the second channel is to first transmit data between DRAM 804 and SRAM 908 through the GDMA 911, and then transmit data between the SRAM 908 and the NRAM 1031 or the WRAM 1032 through the MVDMA 1034. Although it seems that the second channel requires more components to participate and the data stream is longer, in fact, in some embodiments, the bandwidth of the second channel is much greater than that of the first channel, so the communication between the DRAM 804 and the NRAM 1031 or the WRAM 1032 may be more efficient through the second channel. The embodiments of the present disclosure may select the data transmission channel based on their own the hardware conditions.

In other embodiments, the functions of the GDMA 911 and the IODMA 1033 may be integrated in the same component. For the convenience of description. GDMA 911 and IODMA 1033 are considered as different components. For those skilled in the art, as long as the functions they implement and the technical effects they achieve are similar to those of the present disclosure, they belong to the protection scope of the present disclosure. Furthermore, the functions of the GDMA 911, the IODMA 1033, the CDMA 910, and the MVDMA 1034 may also be implemented by the same component. Similarly, as long as the functions they implement and the technical effects they achieve are similar to those of the present disclosure, they belong to the protection scope of the present disclosure.

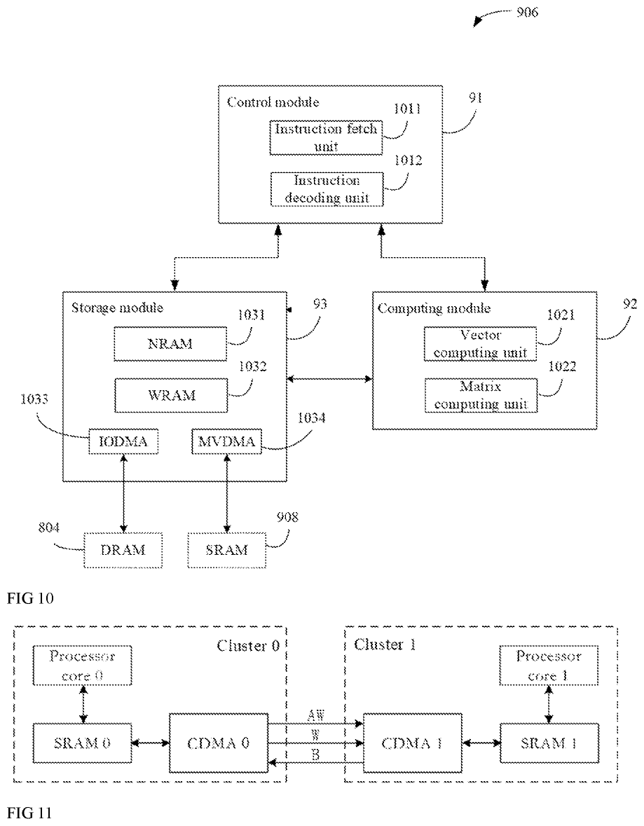

The hardware architecture and its internal structure of the present disclosure are described in detail above in conjunction with FIGS. 7-11. It may be understood that the above description is only exemplary and not restrictive. According to different application scenarios and hardware specifications, those skilled in the art may also make changes to the board (or artificial intelligence device) and its internal structure of the present disclosure, and these changes still fall within the scope of protection of the present disclosure. In addition to the hardware architecture shown in FIGS. 7-11, the solution of the present disclosure also involves a software and hardware architecture, which will be described below.

Based on the above description, those skilled in the art may understand that the present application actually also discloses a device, which includes a processor and a memory. Specifically, the memory may store program instructions for task scheduling, and when the program instructions are executed by the processor, the method steps described in conjunction with FIGS. 1-5 of the present application are implemented. In addition, since the solution of the present application may be implemented by computing program instructions, the present application also discloses a computer-readable storage medium or computer program product, on which a computer program/instruction for task scheduling is stored, thereby implementing the method steps described in conjunction with FIGS. 1-5.

The solution of the present disclosure is described in detail above in conjunction with the accompanying figures. According to different application scenarios, the device or apparatus disclosed herein may include servers, cloud servers, server clusters, data processing devices, robots, computers, printers, scanners, tablet computers, smart terminals. PC (Personal Computer) devices. IoT terminals, mobile terminals, mobile phones, driving recorders, navigators, sensors, cameras, video cameras, camcorder, projectors, watches, headphones, mobile storage, wearable devices, visual terminals, automatic driving terminals, transportation tools, household appliances, and/or medical equipment. The transportation tools include an aircraft, a ship and/or a vehicle: the household appliance comprises a television, an air conditioner, a microwave oven, a refrigerator, an electric cooker, a humidifier, a washing machine, an electric lamp, a gas stove and a cooking machine: the medical device comprises a nuclear magnetic resonance meter, a B-Supervisometer and/or an electrocardiogramonic devices or apparatuses of the present disclosure may also be applied to the fields of the Internet. Internet of Things, data centers, energy sources, traffic, public management, manufacturing, education, grids, telecommunications, finance, retail, worksites, healthcare, and the like.

Further, the device or apparatus of the present disclosure may also be applied to application scenarios related to artificial intelligence, big data, and/or cloud computing such as a cloud, an edge, a terminal and so on. In one or more embodiments, the device or apparatus with high computing power according to the solutions of the present disclosure may be applied to a cloud device (for example, a cloud server), and the device or apparatus with low power consumption may be applied to a terminal device and/or an edge device (for example, a smart phone or a camera). In one or more embodiments, hardware information about a cloud device and hardware information about a terminal device and/or an edge device are compatible with each other, so that appropriate hardware resources can be matched from hardware resources of the cloud device according to the hardware information about the terminal device and/or the edge device to simulate hardware resources of the terminal device and/or the edge device, to achieve unified management, scheduling, and collaborative work of end cloud integration or cloud edge end integration.

It should be noted that, for the purpose of conciseness, the present disclosure describes some methods and embodiments thereof as a series of actions and combinations thereof, but those skilled in the art may understand that the solutions of the present disclosure are not limited by the order of the described actions. Thus, in light of the disclosure or teachings of the present disclosure, those skilled in the art will appreciate that certain steps therein may be performed in other sequences or simultaneously. Further, those skilled in the art can appreciate that the embodiments described in this disclosure can be viewed as being optional, in other words, acts or modules involved therein are not necessarily required for implementation of certain one or more of the schemes of this disclosure. In addition, depending on the different schemes, the present disclosure also has different emphases on the description of some embodiments. In view of this, those skilled in the art can understand the parts not described in detail in one embodiment of this disclosure can also be referred to in the relevant descriptions of other embodiments.

In terms of specific implementation, based on the disclosure and teachings of the present disclosure, those skilled in the art may understand that several embodiments disclosed in the present disclosure may also be implemented in other manners not disclosed herein. For example, for various units in the aforementioned device or apparatus embodiment, the present disclosure divides the units based on the consideration of logical functions, and there may be other division methods in actual implementation. For another example, a plurality of units or components may be combined or integrated into another system, or certain features or functions within a unit or component may be selectively disabled. In terms of connection relationships between different units or components, the connections discussed above in connection with the figures may be direct or indirect couplings between the units or components. In some scenarios, the aforementioned direct or indirect coupling involves a communication connection utilizing an interface that can support electrical, optical, acoustical, magnetic, or other forms of signal transmission.

In the present disclosure, the units described as separate components may or may not be physically separate, and the components shown as units may or may not be physical units. The aforementioned components or units can be located in the same location or distributed across a plurality of network units. In addition, according to actual needs, some or all of the units can be selected to achieve the purpose of the solution described in this disclosed embodiment. Additionally, in some scenarios, a plurality of units in an embodiment of the present disclosure may be integrated into one unit or physically exist separately for each unit.

In some implementation scenarios, the integrated units mentioned above may be implemented in the form of a software program module. If the integrated units are implemented in the form of software program modules and sold or used as an independent product, the integrated units may be stored in a computer-readable memory. Based on this, when the solution of the present disclosure is embodied in the form of a software product (such as a computer-readable storage medium), the software product may be stored in a memory, which may include several instructions to enable a computer device (such as a personal computer, a server or a network device, and the like) to perform some or all steps of the method described in the embodiment of the present disclosure. The aforementioned memory may include but is not limited to various media that may store program codes, such as a USB flash drive, a flash drive, a read only memory (ROM), a random access memory (RAM), a mobile hard disk, a magnetic disk or an optical disk.

In other scenarios, the integrated unit may also be implemented in a form of hardware, in other words, a specific hardware circuit, which may include a digital circuit and/or an analog circuit. The physical implementation of the hardware structure of a circuit can include but is not limited to physical devices, which may include but are not limited to transistors or memristors and the like. In view of this, various devices described herein (such as computing devices or other processing devices) may be implemented through appropriate hardware processors, such as CPU, GPU. FPGA, DSP, ASIC and so on. Furthermore, the aforementioned storage unit or storage device may be any appropriate storage medium (including magnetic storage medium or magneto-optical storage medium, and the like), which may be, for example, resistive random access memory (RRAM), dynamic random access memory (DRAM), static random access memory (SRAM), enhanced dynamic random access memory (EDRAM), high bandwidth memory (HBM), hybrid memory cube (HMC), ROM and RAM, and the like.

The foregoing may be better understood according to the following articles:

Article A1. A method for task scheduling, including:
receiving one or more task streams to be scheduled, where each task stream includes one or more tasks to be distributed for execution:
determining global time and submission time of each current initial task of the one or more task streams respectively:
comparing the global time with the submission time of each current initial task to obtain a comparison result; and
scheduling a current initial task, of which the comparison result satisfies a predetermined condition for distributing and execution.

Article A2. A method of article A1, where a plurality of rounds of determining the global time, determining the submission time, comparing, and scheduling are performed cyclically until the one or more tasks in each of the task streams are distributed.

Article A3. A method of article A1, where determining the global time of each current initial task of the one or more task streams includes:

determining the global time of each current initial task of the one or more task streams based at least on estimated execution time of all tasks that have been distributed in the one or more task streams.

Article A4. A method of article A1, where determining the submission time of each current initial task respectively includes:

for each task stream, determining the submission time of the current initial task in the task stream based at least on estimated execution time of the previous initial task that have been distributed in the task stream.

Article A5. The method of article A1, where the predetermined condition is that the submission time is less than the global time, the method further includes:

scheduling the current initial task corresponding to the submission time for distribution and execution in response to the comparison result being that the submission time is less than the global time.

Article A6. A method of article A4 or A5, where determining the submission time of the current initial task in the task stream includes:

determining completion time of the previous initial task based on the submission time of the previous initial task that have been distributed and its estimated execution time; and determining the completion time of the previous initial task as the submission time of the current initial task:

where an initial value of the submission time of the current initial task is determined based on the completion time and the global time of the current initial task.

Article A7. A method of article A6, where the estimated execution time is associated with execution time of the tasks that have been distributed in the corresponding task stream, and the completion time and the global time are associated with a priority of the corresponding task stream.

Article A8. A method of article A3, where determining the global time of the current initial task of the one or more task streams includes:
determining the minimum submission time of all current initial tasks in the one or more task streams:
determining the global time after the previous initial task is distributed; and selecting a larger value between the minimum submission time and the global time after the previous initial task is distributed as the global time of the current initial task.

Article 9. A method of article A8, where determining the global time after the previous initial task is distributed includes:
determining the global time after the previous initial task is distributed based on the global time before the previous initial task is distributed, the estimated execution time of executing the previous initial task, and the accumulated priority of all task streams.

Article 10. A method of article A9, where the one or more task streams have respective priorities, wherein the accumulated priority is a priority obtained by weighting the priorities of all task streams.

Article A11. A method according to any one of articles A1-A10, further including:
averaging the execution time of the tasks that have been executed in the task stream, so as to use the obtained average value as the estimated execution time of the current initial task in the task stream.

Article A12. The method of article A11, further including:
detecting whether there are a plurality of task streams having different priorities in the task scheduling:
in response to detecting there are a plurality of task streams having different priorities, initiating execution of determining the global time, determining the submission time, comparing, and scheduling the current first task, of which the comparison result satisfies a predetermined condition for distribution and execution.

Article A13. The method of article A11 A12, further including:
detecting whether there is a task stream where no task is distributed within a predetermined time; and
in response to detecting there is a task stream where no task is distributed within the predetermined time, starting execution of the current initial task that determines the global time, determines the submission time, comparing, and schedules the comparison result to satisfy predetermined condition for distribution and execution.

Article A14. The method of article A13, where detecting whether there is a task stream where no task is distributed within a predetermined time includes:
determining a difference between the global time of the current initial task and the global time of the previous initial task:
comparing the difference with a predetermined threshold; and
determining that there is a task stream where no task is distributed within a predetermined time in response to the difference being greater than the predetermined threshold.

Article A15. The method of article A14, further including:
determining the predetermined threshold based on the estimated execution time of the current initial task of the task stream, the number of tasks that have been distributed by the task stream, and a predetermined coefficient, where the predetermined coefficient is associated with the number of task streams to be scheduled and/or the execution time of tasks in other task streams.

Article A16. A device for task scheduling, including:
a processor; and a memory, where the memory stores program instructions for task scheduling, and when the program instructions are run by the processor, the method according to any one of articles A1-A15 is executed.

Article A17. A board card, including: one or more processing chips, each of which includes one or more processing cores: a control device; and a driver program running in the control device and including a software scheduler, where when the driver program is run under the control of the control device, the software scheduler is enabled to execute the method according to any one of articles A1-A15 to distribute tasks in each task stream to the processing chips.

Article A18. A computer-readable storage medium storing computer program instructions for task scheduling, where when the program instructions are executed by a processor, the method according to any one of articles A1-A15 is executed.

Although the embodiments of the present disclosure are as described above, the contents described are merely examples used to facilitate understanding of the present disclosure and are not intended to limit the scope and application scenarios of the present disclosure. Those skilled in the art described in this disclosure may make any modifications and changes in the form and details of implementation without departing from the spirit and scope disclosed in this disclosure, but the scope of patent protection of this disclosure shall still be based on the scope defined by the attached claims.

1. A method for task scheduling, comprising:
receiving one or more task streams to be scheduled, wherein each task stream comprises one or more tasks to be distributed for execution;
determining global time and submission time of each current initial task of the one or more task streams respectively;
comparing the global time with the submission time of each current initial task to obtain a comparison result; and
scheduling a current initial task, of which the comparison result satisfies a predetermined condition for distribution and execution.

2. The method of claim 1, wherein a plurality of rounds of determining the global time, determining the submission time, comparing, and scheduling are performed cyclically until the one or more tasks in each of the task streams are distributed.

3. The method of claim 1, wherein determining the global time comprises:
determining the global time based at least on estimated execution time of all tasks that have been distributed in the one or more task streams.

4. The method of claim 1, wherein determining the submission time of each current initial task respectively comprises:
for each task stream, determining the submission time of the current initial task in the task stream based at least on estimated execution time of the previous initial task that have been distributed in the task stream.

5. The method of claim 1, wherein the predetermined condition is that the submission time is less than the global time, the method further comprising:
scheduling the current initial task corresponding to the submission time for distribution and execution in response to the comparison result being that the submission time is less than the global time.

6. The method of claim 4, wherein determining the submission time of the current initial task in the task stream comprises:
determining completion time of the previous initial task based on the submission time of the previous initial task that have been distributed and its estimated execution time; and
determining the completion time of the previous initial task as the submission time of the current initial task;
where an initial value of the submission time of the current initial task is determined based on the completion time and the global time of the current initial task.

7. The method of claim 6, wherein the estimated execution time is associated with execution time of the tasks that have been distributed in the corresponding task stream, and the completion time and the global time are associated with a priority of the corresponding task stream.

8. The method of claim 3, wherein determining the global time of the current initial task of the one or more task streams comprises:
determining the minimum submission time of all current initial tasks in the one or more task streams;
determining the global time after the previous initial task is distributed; and
selecting a larger value between the minimum submission time and the global time after the previous initial task is distributed as the global time of the current initial task.

9. The method of claim 8, wherein determining the global time after the previous initial task is distributed comprises:
determining the global time after the previous initial task is distributed based on the global time before the previous initial task is distributed, the estimated execution time of executing the previous initial task, and the accumulated priority of all task streams.

10. The method of claim 9, wherein the one or more task streams have respective priorities, wherein the accumulated priority is a priority obtained by weighting the priorities of all task streams.

11. The method of claim 1, further comprising:
averaging the execution time of the tasks that have been executed in the task stream, so as to use the obtained average value as the estimated execution time of the current initial task in the task stream.

12. The method of claim 11, further comprising:
detecting whether there are a plurality of task streams having different priorities in the task scheduling; and
in response to detecting there are a plurality of task streams having different priorities, initiating execution of determining the global time, determining the submission time, comparing, and scheduling the current first task, of which the comparison result satisfies a predetermined condition for distribution and execution.

13. The method of claim 12, further comprising:
detecting whether there is a task stream where no task is distributed within a predetermined time; and
in response to detecting there is a task stream wherein no task is distributed within the predetermined time, initiating execution of determining the global time, determining the submission time, comparing, and scheduling the current first task, of which the comparison result satisfies a predetermined condition for distribution and execution.

14. The method of claim 13, wherein detecting whether there is the task stream wherein no task is distributed within the predetermined time comprises:
determining a difference between the global time of the current initial task and the global time of the previous initial task;
comparing the difference with a predetermined threshold; and
determining that there is a task stream wherein no task is distributed within the predetermined time in response to the difference being greater than the predetermined threshold.

15. The method of claim 14, further comprising:
determining the predetermined threshold based on the estimated execution time of the current initial task of the task stream, the number of tasks that have been distributed by the task stream, and a predetermined coefficient, wherein the predetermined coefficient is associated with the number of task streams to be scheduled and/or the execution time of tasks in other task streams.

16. A device for task scheduling, comprising:
a processor; and
a memory, wherein the memory stores program instructions for task scheduling, and when the program instructions are run by the processor, the method according to any one of claims 1-15 is executed.

17. (canceled)

18. A computer-readable storage medium storing computer program instructions for task scheduling, wherein when the program instructions are executed by a processor, the method according to claim 1.
